(19) United States
(12) Patent Application Publication
(10) Pub. No.: US 2024/0325898 A1
(43) Pub. Date: Oct. 3, 2024

(54) SYSTEMS AND METHODS FOR DYNAMICALLY MODIFYING HIT ZONES ON A DISPLAY SCREEN DEVICE

(71) Applicant: Netflix, Inc., Los Gatos, CA (US)

(72) Inventors: James Smith, Los Gatos, CA (US); Olivier Jean Poitrey, Le Chesnay (FR); Chase Rubin Meusel, Woodbury, MN (US)

(21) Appl. No.: 18/193,622

(22) Filed: Mar. 30, 2023

(51) Int. Cl. A63F 13/537; A63F 13/2145

(52) U.S. Cl. CPC A63F 13/537; A63F 13/2145

(57) ABSTRACT

The disclosed computer-implemented methods and systems can dynamically modify hit zones associated with displayed video game control elements on a display screen device during video game play. For example, the disclosed methods and systems can detect a trigger event associated with the video game that necessitates modifying one or more hit zones on the display screen device while leaving the video game control elements associated with those hit zones unchanged. Various other methods, systems, and computer-readable media are also disclosed.

### BACKGROUND

Video games continue to be a popular and pervasive form of entertainment. Video gaming platforms constantly try to create video games that are faster, more exciting, and more immersive. Typically, a video game is played on a game console or computer that displays game graphics via a display device such as a TV or monitor, while a player interacts with the displayed game via a physical controller or other input device. Video game controllers generally include a collection of physical buttons, joysticks, track pads, paddles, and so forth.

In some instances, such as with mobile gaming, a video game may include buttons and other control elements that are displayed on a touch screen display. For example, some mobile video games may include interactive game control elements that are displayed on a touch screen display of a smartphone. Unfortunately, displayed (as opposed to physical) video game control elements, such as those used in connection with mobile video games, can be difficult to use. To illustrate, players sometimes find it difficult to correctly interact with displayed video game control elements because the displayed buttons, joysticks, etc. aren't physically separated from one another and thus fail to provide users with a physical sense of when one button or control ends and another begins. As such, players often have difficulty hitting the correct video game control elements on a touch screen display while their attention is focused on the video game.

These missed game control element interactions can lead to various inaccuracies. For example, a gaming system may fail to correctly advance game play when a player misses hitting a particular displayed video game control element. Additionally, a gaming system may incorrectly advance game play when a player misses an intended displayed video game control element and rather hits an unintended displayed video game control element.

### SUMMARY

As will be described in greater detail below, the present disclosure describes implementations that dynamically modify one or more hit zones, associated with video game control elements displayed on a display screen device, in response to detecting a trigger event associated with a video game. In one example, a computer-implemented method can include identifying a hit zone layout for a plurality of video game control elements, displayed on a display screen device, that are associated with a video game, detecting a trigger event associated with the video game that necessitates one or more modifications to the hit zone layout on the display screen device, and causing, in response to detecting the trigger event, the display screen device to modify the hit zone layout to favor at least one of the plurality of video game control elements displayed on the display screen device.

In some examples, the display screen device can include a second screen device that functions as a game controller for a video game displayed on a first screen device and the hit zone layout can include a plurality of hit zones, with each hit zone corresponding to a specific video game control element. Additionally, in some examples, detecting the trigger event can include detecting at least one of an in-game event or detecting a user selection related to the hit zone layout.

In some examples, the in-game event can include at least one of gameplay reaching a predetermined point in the video game, gameplay reaching a predetermined level in the video game, encountering a predetermined character in the video game, or encountering a predetermined object in the video game. Furthermore, in some examples, modifying the hit zone layout can include enlarging a hit zone within the hit zone layout and reducing one or more additional hit zones within the hit zone layout that are adjacent to the enlarged hit zone.

In some examples, the method can include detecting an additional trigger event associated with the video game that necessitates an additional modification to the hit zone layout, and causing, in response to detecting the additional trigger event, the display screen device to modify the hit zone layout to an original layout of hit zones.

Some examples described herein include a system with at least one physical processor and physical memory including computer-executable instructions that, when executed by the at least one physical processor, cause the at least one physical process to perform various acts. In at least one example, the computer-executable instructions, when executed by the at least one physical processor, cause the at least one physical processor to perform acts including identifying a hit zone layout for a plurality of video game control elements, displayed on a display screen device, that are associated with a video game, detecting a trigger event associated with the video game that necessitates one or more modifications to the hit zone layout on the display screen device, and causing, in response to detecting the trigger event, the display screen device to modify the hit zone layout to favor at least one of the plurality of video game control elements displayed on the display screen device.

In some examples, the above-described method is encoded as computer-readable instructions on a computer-readable medium. In one example, the computer-readable instructions, when executed by at least one processor of a computing device, cause the computing device to identify a hit zone layout for a plurality of video game control elements, displayed on a display screen device, that are associated with a video game, detect a trigger event associated with the video game that necessitates one or more modifications to the hit zone layout on the display screen device, and cause, in response to detecting the trigger event, the display screen device to modify the hit zone layout to favor at least one of the plurality of video game control elements displayed on the display screen device.

In one or more examples, features from any of the embodiments described herein are used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary environment for implementing a dynamic hit zone system in accordance with one or more implementations.

FIG. 2 is a flow diagram of an exemplary computer-implemented method for dynamically modifying one or more hit zones within a hit zone layout in response to a trigger event in accordance with one or more implementations.

FIG. 3 illustrates how the dynamic hit zone system dynamically modifies hit zones within a hit zone layout in accordance with one or more implementations.

FIG. 4 is a detailed diagram of the dynamic hit zone system in accordance with one or more implementations.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As mentioned above, video games that include displayed (as opposed to physical) video game control elements (e.g., such as control elements displayed on a smartphone used as a video game controller) may give rise to various inaccuracies and overall dissatisfaction with the video game. Often these issues are caused by incorrect or missed user interactions (e.g., incorrect or missed hits) relative to the displayed video game control elements. For example, players may either entirely miss a displayed video game control element or may interact with the wrong video game control element because they cannot feel the location of that video game control element with their fingers while simultaneously focusing on video game graphics. Missed and incorrect video game control element interactions like these can lead to failed or inaccurate gameplay which—in turn—can result in resource waste as network resources are used to transmit incorrect data, incorrect game graphics are rendered, gameplay is restarted, and so forth.

In light of these problems, the present disclosure describes a system that generates and dynamically modifies hit zone layouts associated with displayed video game control elements to improve control accuracy and end user satisfaction. For example, if some but not all control elements are in use in a particular moment or interaction in a video game (e.g., if a particular video game interaction only requires the use of the “A” button but not the “B”, “X”, or “Y” buttons), the described system can dynamically expand the hit zones of those control elements that are in active use (e.g., the “A” button) and contract the hit zones of those that are not (e.g., the “B”, “X”, and “Y” buttons) to improve the chance that a player will correctly trigger the correct control element. As such, the player need not hit the video game control element with total accuracy, but rather can hit anywhere within the expanded hit zone associated with that video game control element in order to interact with that control element.

In some cases, the system described herein may dynamically modify hit zone layouts during gameplay. For example, the described system can enlarge or reduce the hit zone associated with a video game control element depending on what is happening in the video game (e.g., in response to encountering a particular character, level, object, etc.), while leaving the displayed position of the video game control element unchanged. In other examples, the system may detect multiple interactions that miss a video game control element but land toward an edge of that element's associated hit zone. In these examples, the system may determine that the player's hand is not appropriately sized for the current placement of the video game control element and, in response, dynamically modify the size or layout of the same.

Thus, by dynamically implementing hit zone layouts, the described system can increase the accuracy with which players interact with displayed video game control elements on display screen devices, while avoiding any potential confusion that would otherwise arise if the video game control elements were rescaled or repositioned. This increase in accuracy can further lead to resource savings as network resources, display resources, memory resources, processing resources, and other computational resources are left unwasted.

Features from any of the implementations described herein may be used in combination with one another in accordance with the general principles described herein. These and other implementations, features, and advantages will be more fully understood upon reading the following detailed description in conjunction with the accompanying drawings and claims.

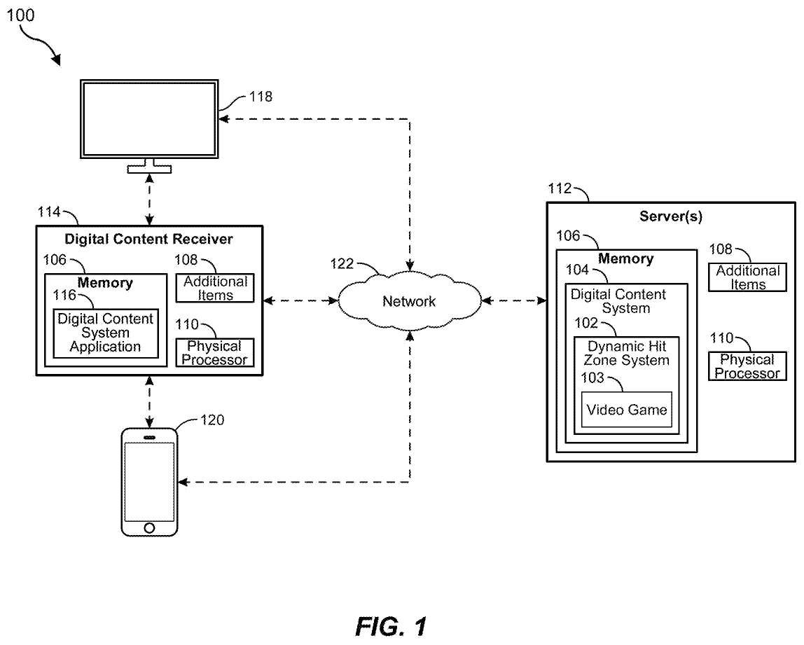

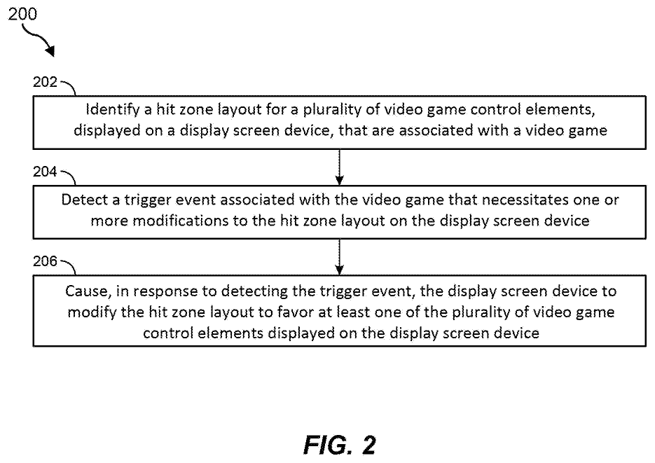

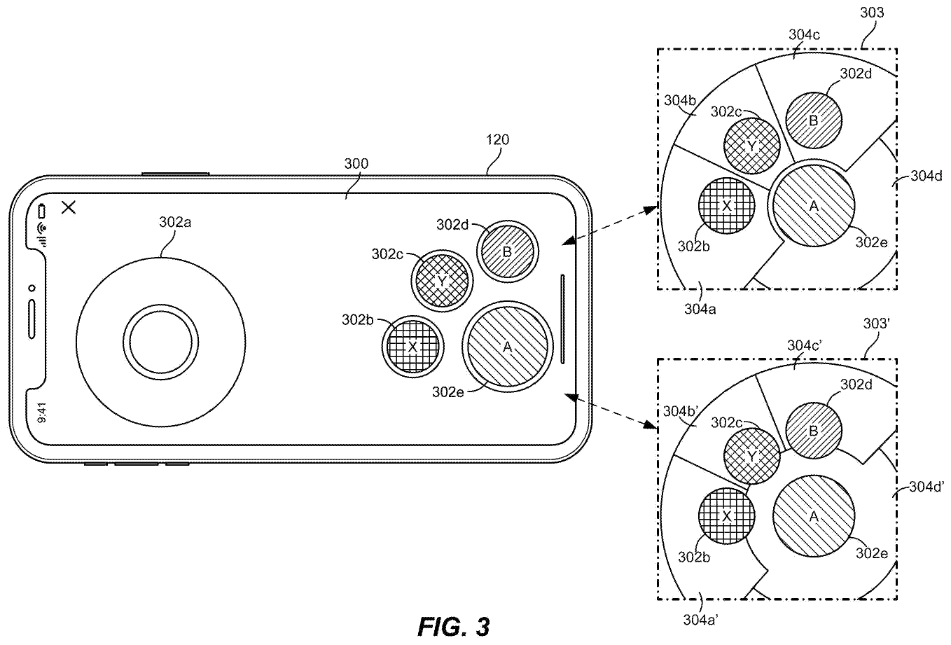

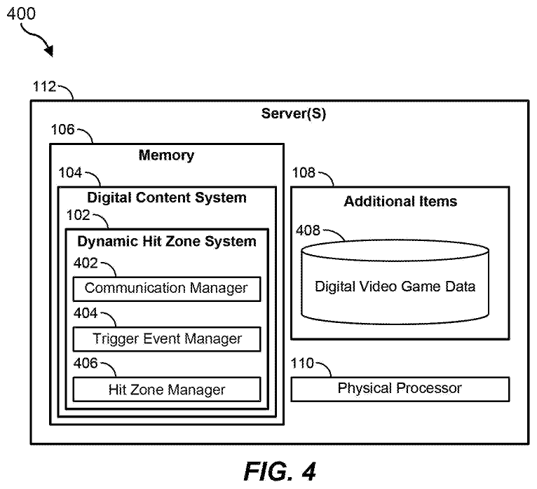

The following will provide, with reference to FIGS. 1-4, detailed descriptions of a dynamic hit zone system that generates and dynamically modifies hit zone layouts on a display screen device during gameplay associated with a video game. For example, an exemplary network environment is illustrated in FIG. 1 to show the dynamic hit zone system operating in connection with a first screen device and a second screen device. FIG. 2 illustrates steps taken by the dynamic hit zone system to dynamically modify a hit zone layout in response to a trigger event. FIG. 3 illustrates additional detail with regard to how the dynamic hit zone system modifies a hit zone in association with one or more video game control elements on a display screen device. Finally, FIG. 4 provides additional detail with regard to the features and functionality of the dynamic hit zone system.

As just mentioned, FIG. 1 illustrates an exemplary networking environment 100 implementing aspects of the present disclosure. For example, the networking environment 100 can include server(s) 112, a digital content receiver 114, a first screen device 118, a second screen device 120, and a network 122. As further shown, the server(s) 112 and the digital content receiver 114 can include a memory 106, additional items 108, and a physical processor 110.

In one or more implementations, as shown in FIG. 1, the first screen device 118 may be a television and the second screen device 120 may be a display screen device such as a smartphone. In some examples, the display of the second screen device 120 is a touch screen display that may serve as a controller for the video game 103 displayed on the first screen device 118. As further shown, the digital content receiver 114 may be a device that is separate from the first screen device 118 and the second screen device 120, and the first screen device 118 may be physically separate from the second screen device 120. In this implementation, the digital content receiver 114, the first screen device 118, and the second screen device 120 may be on the same subnet (e.g., within the same residence or location), or may be on different subnets. In additional implementations, the digital content receiver 114 and/or the functionality of the digital content receiver 114 may be incorporated into the first screen device 118 and/or the second screen device 120. In yet additional implementations, the first screen device 118 may be a digital projector, monitor, or other display device. Similarly, the second screen device 120 may be a tablet computer or a smart wearable device with an interactive display screen.

As further shown in FIG. 1, a dynamic hit zone system 102 may be implemented as part of a digital content system 104 within the memory 106 on the server(s) 112. In one or more implementations, the digital content system 104 may include a subscription streaming service for providing digital media content subscribers. Additionally, the dynamic hit zone system 102 may access the video game 103, run the video game 103, stream output from the video game 103 to one or both of the first screen device 118 and the second screen device 120 (e.g., to cause the first screen device 118 to render game graphics, to cause the second screen device 120 to display video game control elements such as buttons, joysticks, etc.), receive control inputs from a video game controller (e.g., such as the second screen device 120), etc. In one or more implementations, the dynamic hit zone system 102 works in concert with the video game 103 to analyze control inputs, change game states, update game graphics based on the inputs, detect trigger events, and generate and implement dynamic hit zone layouts on the second screen device 120.

As further shown in FIG. 1, the digital content receiver 114 may include a digital content system application 116 within the memory 106. In some implementations, the digital content system application 116 may communicate information to and from the digital content system 104 via the network 122. In at least one implementation, the dynamic hit zone system 102—in concert with the video game 103—may access and utilize data received by the digital content system 104 in modifying hit zone layouts during video game play.

In some implementations, the digital content system application 116 may be additionally installed on the first screen device 118 and/or the second screen device 120. For example, in one implementation, the first screen device 118 may receive video game display information via the digital content receiver 114 and the second screen device 120 may communicate directly with the server(s) 112 via an additional instance of the digital content system application 116 installed thereon. For example, the digital content system application 116 may be embedded on the second screen device 120 such that the second screen device 120 may communicate directly with the digital content system 104 and/or the dynamic hit zone system 102. In an additional implementation, the first screen device 118 may utilize an instance of the digital content system application 116 installed thereon to communicate directly with the digital content system 104 and/or the dynamic hit zone system 102 via the network 122 while the second screen device 120 may utilize a separate instance of the digital content system application 116 installed thereon to communicate directly with the digital content system 104 and/or the dynamic hit zone system 102 also via the network 122. In some implementations, the networking environment 100 may not include the digital content receiver 114.

As mentioned above, the digital content receiver 114 (and in some implementations the first screen device 118 and/or the second screen device 120) may be communicatively coupled with the server(s) 112 through the network 122. In one or more implementations, the network 122 may represent any type or form of communication network, such as the Internet, and may include one or more physical connections, such as a LAN, and/or wireless connections, such as a WAN. In some implementations, the network 122 may represent a telecommunications carrier network. In at least one implementation, the network 122 may represent combinations of networks such that the digital content receiver 114 and the first screen device 118 may communicate with the digital content system 104 via a wireless network while the second screen device 120 may communicate with the dynamic hit zone system 102 via a cellular network.

Although FIG. 1 illustrates components of the exemplary networking environment 100 in one arrangement, other arrangements are possible. For example, in one implementation, the dynamic hit zone system 102 can operate as a native application that may be installed on the digital content receiver 114, the first screen device 118, and/or the second screen device 120. In another implementation, the dynamic hit zone system 102 may operate across multiple servers. Moreover, in some implementations, the exemplary networking environment 100 may include multiple second screen devices 120—such as when a multiplayer game is being played on the first screen device 118. Similarly, the exemplary networking environment 100 may also include multiple first screen devices 118 such as when multiple players are playing a video game on separate displays. For example, in that implementation, the dynamic hit zone system 102 and/or the digital content system 104 can support the same video game being played by multiple players (e.g., on multiple second screen devices and multiple first screen devices) across multiple locations and on different user accounts within the digital content system 104.

In one or more implementations, and as will be explained in greater detail below, the methods and steps performed by the dynamic hit zone system 102 reference multiple terms. For example, a “digital video game” or “video game” can refer to a digital program that causes game graphics to be rendered on a display device, such as a first screen device as user inputs received via a second screen device manipulate or interact with the rendered game graphics. A video game may include points, places, junctures, levels, characters, and other displayed objects.

As used herein, “video game control elements” can refer to interactive graphics displayed on a display screen device. For example, a video game control element can be an interactive graphic that mimics a button. In some implementations, video game control elements can appear to be depressed or otherwise manipulated when selected. Video game control elements may also be grouped together in compositions. A video game control element may be positioned and scaled within a touch screen display of a display screen device.

As used herein, a “hit zone” can refer to an area of a touch screen display that is associated with a video game control element. In one or more implementations, the hit zone may be logically defined within the touch screen display but may not be indicated with any displayed elements. In other words, the hit zone may be invisible but present on the touch screen display. The dynamic hit zone system 102 can define a hit zone by pixel coordinates at vertices of the area. Hit zones may surround all or a portion of their associated video game control elements. Moreover, hit zones may be organized into hit zone layouts. In one or more implementations, a hit zone layout may include multiple hit zones that are adjacent to each other.

As used herein, a “display screen device” can refer to any device with a touch screen display where video game control elements and hit zones may be implemented. For example, in one or more implementations, a display screen device can be a second screen device such as a smartphone that has been temporarily converted by the digital content system 104 into a video game controller.

As used herein, a “trigger event” can refer to an event relative to a video game that necessitates a change in a hit zone layout on a display screen device that serves as a controller for the video game. In some examples, trigger events can be categorized by a specific “type” that indicates the particular change that has occurred. To illustrate, a trigger event can refer to an “in-game event” such as an encounter that has occurred within the video game. A trigger event can also refer to a special character that has been encountered within the video game. As such, certain types of encounters (e.g., an encounter with a new landscape) may not necessitate a hit zone layout change, while other types of encounters-such as encountering a special character or item that can only be interacted with via certain video game control elements—may necessitate a hit zone layout change.

In some instances, a trigger event may be based on an event specific to the video game 103, as described above. In additional instances, a trigger event may be detected in response to a specific interaction received via one or more video game control elements on the second screen device 120. For example, in response to detecting multiple interactions that miss a video game control element but land toward an edge of that element's associated hit zone, the dynamic hit zone system 102 may determine that the player's hand is not appropriately sized for the current placement of the video game control element. In response to this determination, the dynamic hit zone system 102 may enlarge the hit zone to reduce the chance that the player's user selections miss the hit zone altogether.

As mentioned above, FIG. 2 is a flow diagram of an exemplary computer-implemented method 200 for modifying a hit zone layout in connection with video game control elements on the second screen device 120 during gameplay. The steps shown in FIG. 2 may be performed by any suitable computer-executable code and/or computing system, including the system(s) illustrated in FIG. 4. In one example, each of the steps shown in FIG. 2 may represent an algorithm whose structure includes and/or is represented by multiple sub-steps, examples of which will be provided in greater detail below.

As illustrated in FIG. 2, at step 202 the dynamic hit zone system 102 can identify a hit zone layout for a plurality of video game control elements, displayed on a display screen device, that are associated with a video game. For example, the dynamic hit zone system 102 can identify the hit zone layout on the second screen device 120—such as a smartphone—that functions as a game controller for a video game displayed on the first screen device 118. In one or more implementations, the hit zone layout can include non-displayed areas (e.g., hit zones) on a display of the second screen device 120 that correspond to certain video game control elements that are displayed on by the second screen device 120. In at least one implementation, a hit zone associated with a particular video game control element may be larger than the video game control element. As such, a detected interaction with the touch screen display of the second screen device 120 anywhere within the hit zone can be detected by the dynamic hit zone system 102 and/or digital content system 104 (e.g., in connection with the video game 103) as a selection of the video game control element.

As further illustrated in FIG. 2, at step 204 the dynamic hit zone system 102 can detect a trigger event associated with the video game that necessitates one or more modifications to the hit zone layout on the display screen device. For example, the dynamic hit zone system 102 can detect a trigger event by detecting an in-game event such as gameplay reaching a particular point in the video game, gameplay reaching a particular level in the video game, encountering a particular character in the video game, or encountering a predetermined object in the video game. In at least one implementation, such in-game events may make it more likely that a particular video game control element will be used.

In additional implementations, the dynamic hit zone system 102 can detect a trigger event by detecting one or more user selections related to the hit zone layout. For example, the dynamic hit zone system 102 may determine that a threshold number of user interactions with a particular video game control element on the second screen device 120 have been near-misses relative to that video game control element. In response, the dynamic hit zone system 102 may determine that it would be advantageous to increase the size of the hit zone related to that video game control element to reduce the chance of the user missing the video game control element altogether.

As further illustrated in FIG. 2, at step 206 the dynamic hit zone system 102 can cause, in response to detecting the trigger event, the display screen device to modify the hit zone layout to favor at least one of the plurality of video game control elements displayed on the display screen device. For example, the dynamic hit zone system 102 can cause the second screen device 120 to modify the hit zone layout by determining or identifying at least one of the video game control elements that should be favored based on the trigger event. As mentioned above, the trigger event may indicate that a particular video game control element is the only one that may be used at a particular point in the video game. As such, the dynamic hit zone system 102 can cause the second screen device 120 to modify the hit zone layout by enlarging the hit zone associated with that video game control element, and potentially reduce adjacent hit zones within the hit zone layout.

As discussed above, the dynamic hit zone system 102 can dynamically modify a hit zone layout in response to detecting a trigger event. FIG. 3 illustrates additional details with regard to how hit zone layouts may be modified. For example, as shown in FIG. 3, the dynamic hit zone system 102 and/or the digital content system 104—in connection with the video game 103—can cause the second screen device 120 to display video game control elements 302a, 302b, 302c, 302d, and 302e on a touch screen display 300. In one or more implementations, the video game control elements 302a-302e may each be associated with a hit zone. As discussed above, the dynamic hit zone system 102 may not cause any visual indications of the hit zones to be displayed on the touch screen display 300. Instead, the dynamic hit zone system 102 can generate the hit zones as logical areas associated with each of the video game control elements 302a-302e.

In at least one implementation, the dynamic hit zone system 102 and/or the digital content system 104 may group subsets of the video game control elements 302a-302e into compositions. For example, the dynamic hit zone system 102 and/or the digital content system 104 can group the video game control elements 302b-302e into a single video game control composition such that the hit zones associated with the video game control elements 302b-302e are similarly grouped together.

To illustrate, as further shown in FIG. 3, the dynamic hit zone system 102 may associate the video game control elements 302b-302e with a hit zone layout 303. In one or more implementations, the hit zone layout 303 can include the hit zones 304a, 304b, 304c, and 304d. As mentioned above, each of the hit zones 304a-304d defines an area associated with the video game control elements 302b-302e where the dynamic hit zone system 102 may detect user interactions in connection with the video game control elements 302b-302e. In more detail, for example, in response to detecting a user interaction anywhere within the hit zone 304a, the dynamic hit zone system 102 can determine that the user interaction was meant to be directed to the video game control element 302b.

In one or more implementations, the dynamic hit zone system 102 may detect a trigger event during gameplay associated with the video game 103. As discussed above, the dynamic hit zone system 102 can detect an in-game event such as achieving a certain level or can detect repeated near misses within a hit zone associated with a particular video game control element. In response to detecting the trigger event, the dynamic hit zone system 102 can cause the second screen device 120 to modify the hit zone layout 303.

For example, as further shown in FIG. 3, the dynamic hit zone system 102 can cause the second screen device 120 to implement the modified hit zone layout 303′. In one or more implementations, the dynamic hit zone system 102 can cause the second screen device 120 to modify hit zone layout 303 to favor at least one of the video game control elements 302b-302e. To illustrate, the dynamic hit zone system 102 can cause the second screen device 120 to favor the video game control element 302e within the modified hit zone layout 303′ by enlarging the hit zone 304d′ that corresponds to the video game control element 302e. In at least one implementation, the dynamic hit zone system 102 can further reduce the sizes of the hit zones 304a′, 304b′, and 304c′ within the hit zone layout 303′ to accommodate the enlarged hit zone 304d′.

In one or more implementations, the appearance of the touch screen display 300 on the second screen device 120 may not change, even though the hit zone layout has been modified. As such, a player using the second screen device 120 in connection with the video game 103 may detect no change. Instead, the player's interactions with the video game control element 302e may become more accurate because the enlarged hit zone 304d′ creates a larger margin of error for the player's interactions.

In one or more implementations, the dynamic hit zone system 102 can continue to detect additional trigger events during gameplay associated with the video game 103. For example, in response to detecting an additional trigger event (e.g., such as gameplay transitioning from a mini puzzle back to a main quest), the dynamic hit zone system 102 can modify the hit zone layout 303′ back to the original hit zone layout 303. In additional implementations, the dynamic hit zone system 102 can modify the hit zone layout 303′ to a different hit zone layout that favors one of the video game control elements 302b, 302c, or 302d. The dynamic hit zone system 102 can continue modifying the hit zone layout 303 until the player exits the video game 103.

As mentioned above, and as shown in FIG. 4, the dynamic hit zone system 102 performs various functions in connection with dynamically modifying hit zones within a touch screen display in response to detected trigger events. FIG. 4 is a block diagram 400 of the dynamic hit zone system 102 operating within the memory 106 of the server(s) 112 while performing these functions. As such, FIG. 4 provides additional detail with regard to these functions. For example, as shown in FIG. 4, the dynamic hit zone system 102 can include a communication manager 402, a trigger event manager 404, and a hit zone manager 406. As further shown in FIG. 4, the additional items 108 can store and maintain digital video game data 410.

In certain implementations, the dynamic hit zone system 102 may represent one or more software applications, modules, or programs that, when executed by a computing device, may cause the computing device to perform one or more tasks. For example, and as will be described in greater detail below, one or more of the communication manager 402, the trigger event manager 404, or the hit zone manager 406 may represent software stored and configured to run on one or more computing devices, such as the server(s) 112. One or more of the communication manager 402, the trigger event manager 404, and the hit zone manager 406 of the dynamic hit zone system 102 shown in FIG. 4 may also represent all or portions of one or more special purpose computers to perform one or more tasks.

As mentioned above, and as shown in FIG. 4, the dynamic hit zone system 102 can include the communication manager 402. In one or more implementations, the communication manager 402 can receive data from one or more of the digital content receiver 114 and the second screen device 120. For example, the communication manager 402 can receive control event data from the second screen device 120 that indicates which video game control elements and/or hit zones have been interacted with on the touch screen display 300 of the second screen device 120. The communication manager 402 can further transmit data to the one or more of the digital content receiver 114 and the second screen device 120. For example, the communication manager 402 can transmit instructions and other data to the second screen device 120 that causes the second screen device 120 to implement a hit zone layout and/or modify a hit zone layout.

The communication manager 402 can detect user interactions with a fine level of granularity. For example, the communication manager 402 can receive and/or detect tap touch gesture inputs, press-and-hold touch gesture inputs, press-and-slide touch gesture inputs, multi-finger touch gesture inputs, variable pressure touch gesture inputs, sound inputs, or gyroscopic inputs. In one or more implementations, the communication manager 402 can receive and/or detect such control inputs relative to specific video game control elements displayed by the second screen device 120. Additionally, the communication manager 502 can receive and/or detect timing information associated with the control inputs that indicates how quickly video game controls are selected, a sequence in which video game controls are selected, locations of selections relative to corresponding hit zones, and so forth.

As mentioned above, and as shown in FIG. 4, the dynamic hit zone system 102 can include the trigger event manager 404. In one or more implementations, the trigger event manager 404 can analyze data received from the second screen device 120 in connection with the video game 103 to determine whether a trigger event has occurred. For example, the trigger event manager 404 can determine that a particular sequence of control inputs in connection with a current level of gameplay indicates that a trigger event has occurred. For example, the trigger event manager 404 can determine that one or more detected interactions with a video game control element—or its corresponding hit zone—at a particular point or level within the video game 103 (e.g., indicated by the game play data) indicates that a trigger event has occurred. The trigger event manager 404 can perform this analysis in connection with one or more of decision trees, point clouds, databases, video game specified rules, and/or machine learning models.

The trigger event manager 404 can further analyze data received from the second screen device 120 to determine whether user selections related to a hit zone layout qualify as a trigger event. For example, the trigger event manager 404 can determine that there have been more than a threshold number of “near-misses” within a particular hit zone (e.g., user selections that are almost outside the hit zone—indicating that the player's hand may be too big, too small, differently abled, etc.). In response to this determination, the trigger event manager 404 can further determine that a trigger event has occurred. In one or more implementations, the trigger event manager 404 can make this determination based on existing rules or can learn user selection patterns over time utilizing one or more machine learning techniques.

In response to determining that a trigger event has occurred, the trigger event manager 404 can determine what type of trigger event has occurred. For example, the trigger event manager 404 can determine the type of trigger event by analyzing both the user selections relative to video game control elements and/or hit zones and the gameplay data in connection with the video game 103. For instance, the trigger event manager 504 can determine a specific change occurring in the video game 103 and the one or more user selection of video game control elements and/or hit zones that are associated with that specific change. To illustrate, the trigger event manager 404 can analyze the gameplay data to determine that a specific character has been encountered within the video game. By further detecting a sequence of user selections of video game control elements and/or hit zones that indicate that the player's character has approached the specific character, the trigger event manager 404 can determine that the type of trigger event is a special character encounter.

In some implementations, the trigger event manager 404 can determine the type of trigger event based on the programming of the video game 103. For example, the video game 103 can specify that if a player moves to a new level within the video game 103 that a new level type of trigger event has occurred. In some implementations, the trigger event manager 504 can determine the type of trigger event in response to input from the digital content system 104. For example, the dynamic hit zone system 102 can notify the digital content system 104 when a user selection of a particular video game control element indicates access to a digital content system menu. The digital content system 104 may then instruct the dynamic hit zone system 102 that a system menu access type of trigger event has occurred.

In at least one implementation, the trigger event manager 404 can utilize various artificial intelligence techniques to determine the type of trigger event that has occurred. For example, the trigger event manager 404 can generate a machine learning model input based on the received gameplay data and control inputs resulting from user selections of video game control elements and/or associated hit zones. The trigger event manager 404 can further apply a machine learning model to the generated input to generate a trigger event type prediction. For example, the trigger event manager 404 can train the machine learning model to generate trigger event type predictions by applying the machine learning model to training inputs, and then back-propagating generated training predictions over multiple training cycles until the accuracy of the training predictions converges.

As further shown in FIG. 4, and as mentioned above, the dynamic hit zone system 102 can include the hit zone manager 406. In one or more implementations, the hit zone manager 406 can determine whether a particular type of trigger event necessitates modifications to a hit zone layout on the second screen device 120. For example, the trigger event manager 504 can access video game programming data that dictates which types of trigger events at various points in the video game 103 necessitate hit zone layout modifications. To illustrate, the hit zone manager 406 can determine that at a particular point in gameplay following a special character encounter, only two of multiple video game control elements may be used because at that point in gameplay the only gameplay options are to move right or left. As such, the hit zone manager 406 can determine that modifications to the hit zone layout are needed to favor the video game control elements associated with right and left movement.

In response to determining that a trigger event necessitates one or more modifications to the hit zone layout, the hit zone manager 406 can further determine how the hit zone layout should be modified. For example, the hit zone manager 406 can determine which video game control elements should be favored and then determine how the hit zone layout should be modified to favor those video game control elements. To illustrate, the hit zone manager 406 can determine that a trigger video game control element should be favored because gameplay has reached a point in the video game 103 where the only possible action is shooting a weapon. As such, the hit zone manager 406 can determine that the hit zone associated with the trigger video game control element should be enlarged so that the possibility of missed user interactions with the trigger video game control element is reduced. The hit zone manager 406 can determine that the hit zone should be enlarged by a number of pixels (e.g., in one direction, in all directions), or by a percentage (e.g., enlarged by 15%).

In some implementations-such as when video game control elements are positioned together as part of a composition—the hit zone manager 406 can further reduce the size of other hit zones adjacent to the enlarged hit zone. For example, the hit zone manager 406 can reduce the size of adjacent hit zones by as many pixels as the favored hit zone was enlarged. In one or more implementations, the hit zone manager 406 can modify the size and shape of the adjacent hit zones based on other considerations such as the likelihood that the other associated video game control elements will be used at the current point in gameplay.

As shown in FIGS. 1 and 4, the server(s) 112 and the digital content receiver 114 can include one or more physical processors, such as the physical processor 110. The physical processor 110 can generally represent any type or form of hardware-implemented processing unit capable of interpreting and/or executing computer-readable instructions. In one implementation, the physical processor 110 may access and/or modify one or more of the components of the dynamic hit zone system 102. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, the server(s) 112 and the digital content receiver 114 can include the memory 106. In one or more implementations, the memory 106 generally represents any type or form of volatile or non-volatile storage device or medium capable of storing data and/or computer-readable instructions. In one example, the memory 106 may store, load, and/or maintain one or more of the components of the dynamic hit zone system 102. Examples of the memory 106 can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Moreover, as shown in FIG. 4, the server(s) 112 and the digital content receiver 114 can include the additional items 108. On the server(s) 112, the additional items 108 can include the digital video game data 408. In one or more implementations, the digital video game data 408 can include the video game 103 along with the video game control element and hit zone layout information associated with the video game 103. The digital video game data 408 can also include information used in determining whether a trigger event has occurred.

In summary, the dynamic hit zone system 102 can increase the efficiency and accuracy with which video game control elements are selected during gameplay by expanding and contracting hit zones in real time. For example, as discussed above, the dynamic hit zone system 102 can detect trigger events (e.g., specific gameplay encounters, player mishits, etc.) and modify individual hit zones within a hit zone layout on display screen device (i.e., the second screen device 120) such that video game control elements associated with the trigger event are easier to select correctly. By modifying the hit zones associated with video game control elements in real time in this way, the dynamic hit zone system 102 can reduce the computational waste associated with missed user selections of that video game control element and incorrect user selections of other video game control elements, resulting in improved player satisfaction and enjoyment.

### EXAMPLE EMBODIMENTS

Example 1: A computer-implemented method for dynamically modifying one or more hit zones in response to detecting a trigger event associated with a video game. For example, the method may include identifying a hit zone layout for a plurality of video game control elements, displayed on a display screen device, that are associated with a video game, detecting a trigger event associated with the video game that necessitates one or more modifications to the hit zone layout on the display screen device, and causing, in response to detecting the trigger event, the display screen device to modify the hit zone layout to favor at least one of the plurality of video game control elements displayed on the display screen device.

Example 2: The computer-implemented method of Example 1, wherein the display screen device includes a second screen device that functions as a game controller for a video game displayed on a first screen device.

Example 3: The computer-implemented method of any of Examples 1 and 2, wherein the hit zone layout includes a plurality of hit zones, with each hit zone corresponding to a specific video game control element.

Example 4: The computer-implemented method of any of Examples 1-3, wherein detecting the trigger event includes detecting at least one of an in-game event or detecting a user selection related to the hit zone layout.

Example 5: The computer-implemented method of any of Examples 1-4, wherein the in-game event includes at least one of gameplay reaching a predetermined point in the video game, gameplay reaching a predetermined level in the video game, encountering a predetermined character in the video game, or encountering a predetermined object in the video game.

Example 6: The computer-implemented method of any of Examples 1-5, wherein modifying the hit zone layout includes enlarging a hit zone within the hit zone layout and reducing one or more additional hit zones within the hit zone layout that are adjacent to the enlarged hit zone.

Example 7: The computer-implemented method of any of Examples 1-6, further including detecting an additional trigger event associated with the video game that necessitates an additional modification to the hit zone layout, and causing, in response to detecting the additional trigger event, the display screen device to modify the hit zone layout to an original layout of hit zones.

In some examples, a system may include at least one processor and a physical memory including computer-executable instructions that, when executed by the at least one processor, cause the at least one processor to perform various acts. For example, the computer-executable instructions may cause the at least one processor to perform acts including identifying a hit zone layout for a plurality of video game control elements, displayed on a display screen device, that are associated with a video game, detecting a trigger event associated with the video game that necessitates one or more modifications to the hit zone layout on the display screen device, and causing, in response to detecting the trigger event, the display screen device to modify the hit zone layout to favor at least one of the plurality of video game control elements displayed on the display screen device.

Additionally in some examples, a non-transitory computer-readable medium can include one or more computer-executable instructions that, when executed by at least one processor of a computing device, cause the computing device to perform various acts. For example, the one or more computer-executable instructions may cause the computing device to identify a hit zone layout for a plurality of video game control elements, displayed on a display screen device, that are associated with a video game, detect a trigger event associated with the video game that necessitates one or more modifications to the hit zone layout on the display screen device, and cause, in response to detecting the trigger event, the display screen device to modify the hit zone layout to favor at least one of the plurality of video game control elements displayed on the display screen device.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of,” Finally, for ease of use, the terms “including” and “having” (and their derivatives), as used in the specification and claims, are interchangeable with and have the same meaning as the word “comprising.”

What is claimed is:

1. A computer-implemented method comprising:
identifying a hit zone layout for a plurality of video game control elements, displayed on a display screen device, that are associated with a video game;
detecting a trigger event associated with the video game that necessitates one or more modifications to the hit zone layout on the display screen device; and
causing, in response to detecting the trigger event, the display screen device to modify the hit zone layout to favor at least one of the plurality of video game control elements displayed on the display screen device.

2. The computer-implemented method of claim 1, wherein the display screen device comprises a second screen device that functions as a game controller for a video game displayed on a first screen device.

3. The computer-implemented method of claim 1, wherein the hit zone layout comprises a plurality of hit zones, with each hit zone corresponding to a specific video game control element.

4. The computer-implemented method of claim 1, wherein detecting the trigger event comprises detecting at least one of an in-game event or detecting a user selection related to the hit zone layout.

5. The computer-implemented method of claim 4, wherein the in-game event comprises at least one of: gameplay reaching a predetermined point in the video game, gameplay reaching a predetermined level in the video game, encountering a predetermined character in the video game, or encountering a predetermined object in the video game.

6. The computer-implemented method of claim 1, wherein modifying the hit zone layout comprises enlarging a hit zone within the hit zone layout and reducing one or more additional hit zones within the hit zone layout that are adjacent to the enlarged hit zone.

7. The computer-implemented method of claim 1, further comprising:
detecting an additional trigger event associated with the video game that necessitates an additional modification to the hit zone layout; and
causing, in response to detecting the additional trigger event, the display screen device to modify the hit zone layout to an original layout of hit zones.

8. A system comprising:
at least one physical processor; and
physical memory comprising computer-executable instructions that, when executed by the at least one physical processor, cause the at least one physical processor to perform acts comprising:
identifying a hit zone layout for a plurality of video game control elements, displayed on a display screen device, that are associated with a video game;
detecting a trigger event associated with the video game that necessitates one or more modifications to the hit zone layout on the display screen device; and
causing, in response to detecting the trigger event, the display screen device to modify the hit zone layout to favor at least one of the plurality of video game control elements displayed on the display screen device.

9. The system of claim 8, wherein the display screen device comprises a second screen device that functions as a game controller for a video game displayed on a first screen device.

10. The system of claim 8, wherein the hit zone layout comprises a plurality of hit zones, with each hit zone corresponding to a specific video game control element.

11. The system of claim 8, wherein detecting the trigger event comprises detecting at least one of an in-game event or detecting a user selection related to the hit zone layout.

12. The system of claim 11, wherein the in-game event comprises at least one of: gameplay reaching a predetermined point in the video game, gameplay reaching a predetermined level in the video game, encountering a predetermined character in the video game, or encountering a predetermined object in the video game.

13. The system of claim 8, wherein modifying the hit zone layout comprises enlarging a hit zone within the hit zone layout and reducing one or more additional hit zones within the hit zone layout that are adjacent to the enlarged hit zone.

14. The system of claim 8, further comprising computer-executable instructions that, when executed by the at least one physical processor, cause the at least one physical processor to perform acts comprising:
detecting an additional trigger event associated with the video game that necessitates an additional modification to the hit zone layout; and
causing, in response to detecting the additional trigger event, the display screen device to modify the hit zone layout to an original layout of hit zones.

15. A non-transitory computer-readable medium comprising one or more computer-executable instructions that, when executed by at least one processor of a computing device, cause the computing device to:
identify a hit zone layout for a plurality of video game control elements, displayed on a display screen device, that are associated with a video game;
detect a trigger event associated with the video game that necessitates one or more modifications to the hit zone layout on the display screen device; and
cause, in response to detecting the trigger event, the display screen device to modify the hit zone layout to favor at least one of the plurality of video game control elements displayed on the display screen device.

16. The non-transitory computer-readable medium of claim 15, wherein the display screen device comprises a second screen device that functions as a game controller for a video game displayed on a first screen device.

17. The non-transitory computer-readable medium of claim 15, wherein the hit zone layout comprises a plurality of hit zones, with each hit zone corresponding to a specific video game control element.

18. The non-transitory computer-readable medium of claim 15, wherein detecting the trigger event comprises detecting at least one of an in-game event or detecting a user selection related to the hit zone layout.

19. The non-transitory computer-readable medium of claim 18, wherein the in-game event comprises at least one of: gameplay reaching a predetermined point in the video game, gameplay reaching a predetermined level in the video game, encountering a predetermined character in the video game, or encountering a predetermined object in the video game.

20. The non-transitory computer-readable medium of claim 15, wherein modifying the hit zone layout comprises enlarging a hit zone within the hit zone layout and reducing one or more additional hit zones within the hit zone layout that are adjacent to the enlarged hit zone.
